(19) United States
(12) Patent Application Publication
(10) Pub. No.: US 2024/0271401 A1
(43) Pub. Date: Aug. 15, 2024

(54) A BIOWASTE CONTAINER AND A BIOWASTE COLLECTION SYSTEM

(71) Applicant: Ber Oy, Tampere (FI)

(72) Inventors: Joonas Salonen, Tampere (FI); Jouni Salonen, Tampere (FI)

(73) Assignee: Ber Oy, Tampere (FI)

(21) Appl. No.: 18/569,685

(22) PCT Filed: Jun. 13, 2022
(86) PCT No.: PCT/FI2022/050407

§ 371 Date: Dec. 13, 2023

(30) Foreign Application Priority Data
Jun. 16, 2021 (FI) 20215708

(51) Int. Cl. E03C 1/266; B65F 1/00; B65F 1/12

(52) U.S. Cl. CPC E03C 1/266; B65F 1/0093; B65F 1/127; B65F 2210/132

(57) ABSTRACT

A two-part biowaste container for crushed biowaste includes a first part of the container for solid part of the crushed biowaste, a second part of the container for liquids separated from the crushed biowaste, which second part of the container is arranged below the first part of the container, a separating wall between the first part and the second part, a separating means arranged to the separating wall and being configured to separate at least a part of the liquids from the crushed biowaste from the first part to the second part, a drain connection in the second part for separated liquids, and a separating valve arranged to the separating wall that separates at least a part of the liquids from the crushed biowaste from the first part to the second part of the container.

### FIELD

The aspects of the disclosed embodiments relate to a two-part biowaste container.

The aspects of the disclosed embodiments also relate to a biowaste collection system comprising a two-part biowaste container.

### BACKGROUND

Biogas and, for example, ethanol production needs biodegradable feedstocks like inedible biowaste from shops, households, communities, schools and restaurants, commercial garden waste, as well as many other types of biodegradable fractions. Biodegradable feedstocks are transported to a biogas plant where biogas is produced from them. Upgraded biogas is composed of odorless methane that is lighter than air and it is clean, environmentally friendly energy. Biogas may be used as gas vehicle fuel, energy for product manufacture, in heat and power production as well as in restaurants and homes. The efficiency of biogas production is even improved when the biowaste used does not contain large amounts of water, fluid, or liquids.

CN208828530 discloses a garbage can for carrying out solid-liquid separation on garbage. The garbage can comprises a garbage can body, a push-pull mechanism, a solid-liquid separation mechanism and a pressurizing mechanism. The solid-liquid separation mechanism comprises a conical baffle and a one-way valve at the tip of the tapered baffle.

CN111732465 discloses an integrated device for composting and anaerobic digestion of vegetable waste. The device has a recovery tank whose inside is divided into a compost chamber and a biogas chamber having a separating valve there between. The separating wall is a concave plate structure with a downward convex middle part, and the bottom of the separating wall having a separating valve underneath it.

### SUMMARY

Now there has been invented a two-part biowaste container comprising a separation means for separating at least a part of liquids of crushed biowaste and a biowaste collection system comprising the biowaste container, by which a user-friendly, efficient, and biogas production suitable biowaste collection container and system is provided. Various aspects of the disclosed embodiments include a two-part biowaste container for a biowaste collection system and a biowaste collection system, which are characterized by what is stated in the independent claims. Various embodiments of the aspects of the disclosed embodiments are disclosed in the dependent claims.

According to a first aspect, there is provided two-part biowaste container for crushed biowaste. The two-part biowaste container comprises an inlet, a first part of the container for solid part of the crushed biowaste, a second part of the container for liquids separated from the crushed biowaste, which second part of the container is arranged below the first part of the container, a separating wall between the first part and the second part, a separating means arranged to the separating wall and being configured to separate at least a part of the liquids from the crushed biowaste from the first part to the second part, and a drain connection in the second part for separated liquids. The two-part biowaste container further comprises a separating valve arranged to the separating wall and being configured to separate at least a part of the liquids from the crushed biowaste from the first part to the second part of the container

According to an embodiment, the drain connection is a pump arranged inside the second part of the container, which pump is configured to pump the separated liquids from the second part to a drain through the drain outlet. According to an embodiment, the drain connection is a gravity-operated drain connection in the second part of the container and is connected to a main drain. According to an embodiment, the two-part biowaste container further comprises an inlet, for the crushed biowaste. According to an embodiment, the two-part biowaste container further comprises a biowaste outlet in the first part of the container for suction of non-separated part of the biowaste from the container. According to an embodiment, the two-part biowaste container further comprises a degreasing wall arranged in the second part of the container for separating grease from other liquids. According to an embodiment, the degreasing wall is a wall in the second part of the container that is off the floor of the container. According to an embodiment, the degreasing wall is a wall in the second part of the container comprising a pipe connection for non-greasy part of liquids flowing from a first side of the wall to the second side of the wall through the pipe connection. According to an embodiment, the degreasing wall comprises two adjacent walls in the second part of the container wherein a first wall of the two adjacent walls is off the floor of the container and a second wall of the two adjacent walls is off the ceiling of the second part of the container. According to an embodiment, the container further comprises a water pressure sensor in the second part configured to measure liquid level in the second part of the container. According to an embodiment, the container further comprises an ultrasonic sensor configured to measure biowaste level in the first part of the container. According to an embodiment, the pump is a submersible pump. According to an embodiment, the container further comprises a housing with a lid for pump. According to an embodiment, the container further comprises a biowaste mill for crushing biowaste before entering to the container.

According to a second aspect, there is provided a biowaste collection system comprising a biowaste mill for crushing biowaste, a biowaste drain for crushed biowaste and a two-part biowaste container according to the first aspects and its embodiments, wherein the biowaste drain is arranged between the biowaste mill and the two-part biowaste container so that the crushed biowaste is diverted to the first part of the two-part biowaste container trough the biowaste inlet.

According to an embodiment, the two-part biowaste container is arranged to receive crushed biowaste from at least one biowaste mill through a biowaste drain. According to an embodiment, the two-part biowaste container is arranged to receive crushed biowaste from at least two biowaste mills through a biowaste drain. According to an embodiment, the biowaste mill is arranged under a first sink for receiving biowaste to be crushed by the biowaste mill. According to an embodiment, the biowaste collection system further comprises a second sink for water and other liquids that is connected to the drain. According to an embodiment, wherein the at least one biowaste mill and a water supply device are arranged in connection with a sink. According to an embodiment, the biowaste collection system further comprises a second sink for water and other liquids, the sink is connected to the drain According to an embodiment, the biowaste collection system is in common for at least two buildings. According to an embodiment, the biowaste collection system comprises only one two-part biowaste container for at least two buildings.

According to a third aspect, there is provided a method for collecting solid part and liquid part of crushed biowaste separately, the method comprises: receiving crushed biowaste to a first part of the container for solid part of the crushed biowaste, and separating at least a part of the liquids from the crushed biowaste to a second part of the container through a separating valve arranged to a separating wall arranged between the first part and the second part, which second part of the container is arranged below the first part of the container, so that the solid part of the crushed biowaste remains in the first part of the container.

According to an embodiment, the method is performed by a two-part biowaste container (100, 400, 501) according to the first aspect and it example embodiments.

### DESCRIPTION OF THE DRAWINGS

In the following, various embodiments of the present disclosure will be described in more detail with reference to the appended drawings, in which

FIG. 1a shows a cross-sectional view of a two-part biowaste container for a biowaste collection system according to an example embodiment;

FIG. 1b shows an enlargement view of a mushroom-shaped valve of FIG. 1a;

FIG. 1c shows a view of the mushroom-shaped valve of FIG. 1b and the separating layer from above;

FIG. 1d shows a side view of the mushroom-shaped valve of FIG. 1b without a hat of the mushroom;

FIG. 1e shows a biowaste inlet of the two-part biowaste container of FIG. 1a along a line A-A;

FIG. 1f shows a view of the biowaste inlet of the two-part biowaste container of FIG. 1e from the direction of inside of the container;

FIG. 1g shows a side view of a mushroom-shaped valve according to an example embodiment;

FIG. 2a shows from above a perforated separating layer of a two-part container according to an example embodiment;

FIG. 2b shows from a side the perforated separating layer of FIG. 2a;

FIG. 2c shows from above a perforated separating layer of a two-part container according to an example embodiment.

FIG. 3a shows a cross-sectional view of a two-part biowaste container with a degreasing wall according to an example embodiment;

FIG. 3b shows a cross-sectional view of a two-part biowaste container with sensors according to an example embodiment;

FIG. 4a shows from above a two-part biowaste container according to an example embodiment;

FIG. 4b shows from above the separating layer of the two-part biowaste container of FIG. 4a with openings;

FIGS. 5a, b show a biowaste collection system according to an example embodiment; and

FIG. 6a, b show from above a two-part biowaste container according to an example embodiment.

### DESCRIPTION OF EXAMPLE EMBODIMENTS

A biowaste mill is an electrically operated gadget fitted permanently below a kitchen sink. The term “biowaste mill” covers in this context all devices suitable for crushing biowaste, for example, leftovers or fruit peels fed to it. Such a device may be, for example, a food waste mill, a waste disposer, a food waste grinder, a food waste treatment apparatus, etc. When the biowaste mill is fixed below a kitchen sink and switched on and the tap is opened, food wastes like bones, eggshells, leftover food, vegetable and fruit peels, banana leaves etc. get crushed into fine particles and drain down a biowaste drain. The biowaste drain is a drain line that is a hollow pipe, which is arranged to convey the crushed biowaste from the biowaste mill to a biowaste container according to example embodiments.

The described example embodiments of the present disclosure relate to a two-part biowaste container. The two-part biowaste container is usually arranged at least partly underground. The crushed biowaste is diverted to the two-part biowaste container and more precisely into a first i.e. upper part of the two-part biowaste container through a biowaste inlet. Below the first part of the container there is a second part of the container and between them there is a separating layer acting as a bottom for the first part of the container and a ceiling for the second part of the container. In the separating layer, there are separating means configured to separate at least part of the liquids from the crushed biowaste. The term “liquid” covers in this context all fluids, water, and liquid substance of crushed biowaste. The separating means may be, for example, a mushroom-shaped valve structure with one or more holes i.e. openings for the liquids under the mushroom hat layer in the top or upper part of the mushroom foot. The liquid gathers and floats on the surface of the biowaste and will at least partly or mainly be separated to the second part of the biowaste container through the one or more openings of the valve structure. The separating means may however be just perforations formed to the separating layer instead a valve structure.

The liquid gathers to the second i.e. lower part of the two-part container. In the second part of the container there is a pump configured to pump the gathered liquids to a drain through a drain pipeline and drain connection. The drain connection is connected to a main drain raking liquids out of a house to sewerage network. The pump may be arranged in a housing having a lid preventing biowaste to enter the housing and pump from above. The pump may be any suitable pump, for example, a submersible pump, which is configured to pump liquids from the second part of the container to the drain. In addition, when the lid of the housing is opened i.e. lifted, the pump and drain pipeline (when disconnected from drain connection) can be lifted from the housing and from the container for maintenance or for changing. The pump may comprise a start button, so that it is possible to start the pumping by pushing the button. The pump may, however, also be controlled remotely by a remote controller. The remote controller controlling the remotely controllable pump may be, for example, any device capable of transmitting wireless control signals to the pump. The remote controller comprises a transmitter. The transmitter may comprise a microprocessor chip which is connected to a battery of the remote controller, an RF transmitter or a Bluetooth wireless transmitter with an antenna, and a control circuitry for transmitting control signals to the receiver of the pump. The remote controller thus transmits control signals, for example, over a short range radio connection, a long range radio connection a Bluetooth connection or a low-power consumption Bluetooth connection to the motor of refining system. The remote controller and the remotely controllable pump have devices for transmitting/receiving control signals, for example, both may use RF, Bluetooth, or low-power consumption Bluetooth connection. Alternatively, the pump may operate automatically. It may be configured to operate periodically, for example, once a day, every other day or once a week. It is also possible that the pump comprises its own surface level regulator and when it rises above a predetermined level, the pump starts pumping.

The un-separated i.e. un-filtered part of the biowaste that is more solid part of the biowaste and may called as solid biowaste remains in the first part i.e. in the upper part of the two-part biowaste container waiting for emptying i.e. collecting of the biowaste and transporting, for example, to a biogas plant where biogas may be produced from it. It should be noted that even the un-filtered part of the biowaste i.e. so called solid biowaste in the first part of the two-part biowaste container comprises liquids and can be said to be wet waste. In other words, only the liquid part of the biowaste will transfer to the second part of the container. And as liquid part of the biowaste is at first separated to the second part and then pumped or otherwise transferred, for example flowed, to the drain connection or drain, the first part of the biowaste container can store more organic solid material, which also requires less space than the usual non-separated biowaste, which means that the emptying interval increases. In addition, solid biowaste in the two-part biowaste container may smell less, because the liquids may not ferment.

The two-part biowaste container comprises a biowaste outlet i.e. an emptying connection on top or on the side of the biowaste container so that it is possible to empty the non-filtered part (more solid part) of the crushed biowaste from the biowaste container by a vehicle comprising a suction device or some other means suitable for emptying the first part of the two-part biowaste container. The end part of the biowaste outlet arranged inside the container may, for example, extend to the bottom of the first container i.e. near a surface of a separating wall wherein the biowaste material to be sucked is usually more solid than near the surface of biowaste material. The biowaste outlet may be a vacuum piping. However, it is also possible that the container does not comprise a biowaste outlet but the non-separated part of the biowaste material is emptied and sucked via the open upper part of the container after a lid of the container is opened.

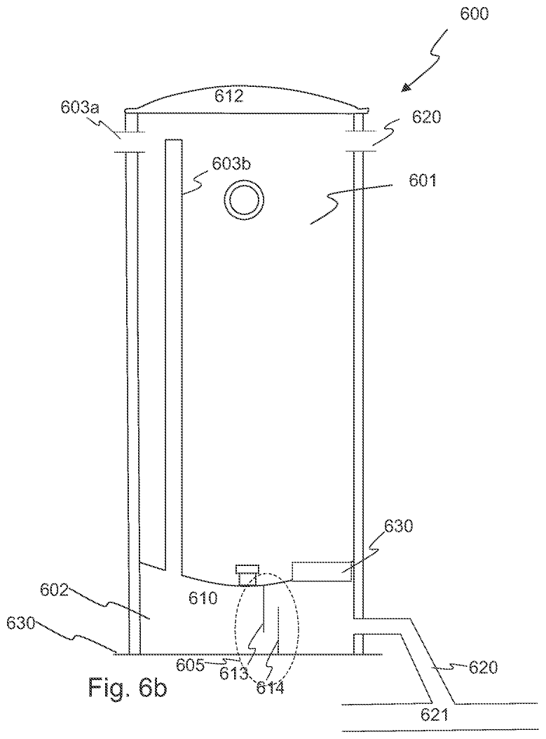

The lower i.e. second part of the two-part container may further comprise a degreasing wall. The degreasing wall may be arranged in the second part of the container, under a separating wall and may be attached or fixed to it. It may further extend to the sides i.e. walls of the container, but there may still remain a small gap or slit between a floor of the second part and the lower edge of the degreasing wall so that grease possibly mixed to the liquids remains in the first side of the degreasing wall but other parts of the liquids i.e. a non-greasy part, will flow through the gap or the slit to the second side of the degreasing wall comprising a pump configured to pump the non-greasy part of the liquid to the main drain. This flowing is possible due to that the grease floats on top of the non-greasy part of the liquids, which enables flowing of non-greasy part through the gap under the degreasing wall to the second side. The ratio of the volumes of the first and second parts divided by the degreasing wall may be, for example, 3:1. The degreasing wall may also have some other shape, two possible alternatives as a degreasing wall are shown, for example, in FIGS. 6a and 6b.

The two-part biowaste container may further comprise one or more sensors and an electrical box to which the sensors are electrically connected, and electrical box which supplies electricity to the sensors and may comprise a control unit, which may analyse a value measured by a sensor and control, for example, by a control signal a pump based on the value. The control signal, may for example, start or stop the pump. In connection with the electrical box, there may be sensor data transferring means or unit, for example, a transmitter or transceiver configured to transmit the gathered sensor data, for example, to a waste management company or anywhere where this kind of data is needed. The first sensor may be a water pressure sensor, which is configured to measure water pressure level. The measuring can be performed, for example, inside a tubular housing, which lower end is arranged in the second part of the container. When the sensor measures a water pressure reading which exceeds a max threshold value set for the water pressure, the pump may automatically start pumping the liquids to the main drain or after receiving, for example, a control signal, or the water pressure reading(s) may be transmitted to a waste management company or owner of the container, which then monitors the readings and takes care of starting the pumping by a control signal or manually. The pump may be arranged to pump for a certain period or until one of the following measured water pressure readings is under another predetermined threshold value. The tubular housing may be arranged around the water pressure sensor and its wiring and the housing may extend from the upper part of the container to the second part of the container, whereas the sensor itself is in the upper part of the housing in the first part of the container. The sensor is arranged to measure water pressure level inside this housing. Any technology other than a water pressure sensor may be used to control the pump, starting and stopping, the pump. The other technology may use other type of sensor or sensors, but it may also be based on some other technology.

The second sensor may be, for example, an ultrasonic sensor, arranged in the upper part of the first part of the container and configured to measure biowaste level in the second part of the container. The sensor may transmit measured readings to a waste management company or owner of the container, which then monitors readings and takes care of emptying of the more solid biowaste from the first part of the container.

The control unit may also be so called external control unit arranged outside the container. In that case signaling is performed via wired or wireless connection(s) using any existing suitable technology, e.g. Bluetooth, wi-fi etc.

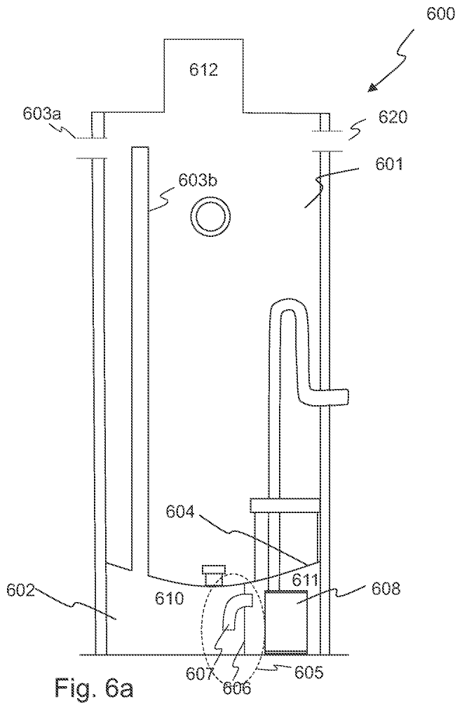

In addition to above mentioned, the two-part biowaste container may also comprise one or more ventilation hatches, pipes for example, a ventilation pipe or pipes, or openings in connection with the container, lid of the container or, for example, with the biowaste outlet, and a flushing connection through which flushing liquid is fed to the container. A ventilation pipe or pipes may be arranged to ventilate the first part of the container and/or the second part of the container. Examples of ventilation pipes are shown in FIGS. 5a, 6a and 6b. The ventilation of the second part of the container may also be performed, in addition or instead of ventilation pipe or pipes, through a connection to a drain, for example, a drain corresponding a drain 508 shown in FIG. 5a.

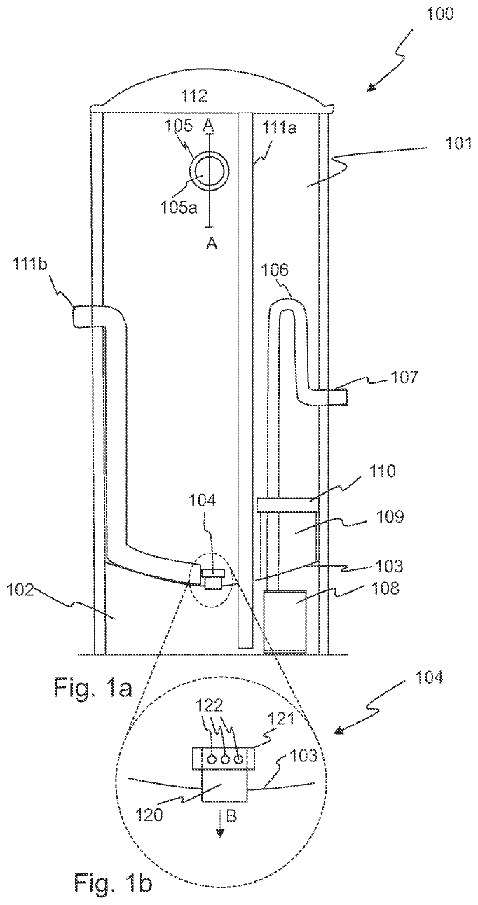

In the following, several embodiments of the present disclosure will be described in the context of FIGS. 1 to 6b. It is to be noted, however, that the aspects of the disclosed embodiments are not limited to shown embodiments of a two-part biowaste containers or a biowaste collection system. In fact, the different embodiments have applications in any environment where a two-part biowaste container and/or a biowaste collection system is suitable to be used.

FIG. 1 shows a cross-sectional view of a two-part biowaste container 100 for a biowaste collection system according to an example embodiment. As the name of the container refers, the two-part biowaste container 100 comprises two separate portions i.e. parts, an upper part i.e. first part 101 and a lower part i.e. a second part 102 underneath the first part 101. There is a separating wall 103 between the first part 101 and the second part 102. The separating wall 103 may have a concave shape so that its center is lower than its edges. The first part 101 of the two-part biowaste container 100 is arranged to receive crushed biowaste and store solid part of the crushed biowaste, whereas the second part 102 is for liquids separated i.e. filtered from the crushed biowaste. The two-part biowaste container 100 further comprises a separating means 104 arranged to the separating wall 103 and being configured to separate liquids from the crushed biowaste from the first part 101 to the second part 102. In this example the separating means 104 is a mushroom-shaped valve comprising openings, underneath the hat of the mushroom, for liquid part of the crushed biowaste so that the liquids can drain to the second part 102.

The two-part biowaste container 100 comprises an inlet 105 for crushed biowaste and a drain outlet comprising a drain pipeline 106, which first end is connected to a drain connection 107. The inlet 105 for crushed biowaste may comprise a flap 105a, preventing possible odors to enter the pipeline (part of pipeline shown in FIG. 1e) through which the crushed biowaste enters the container 100. The flap 105a opens when crushed biowaste enters the container 100. The drain outlet is arranged to be connected to a drain and further to a main drain raking liquids out of a house to sewerage network. The two-part biowaste container 100 further comprises a pump 108 arranged inside the second part 102 of the container 100. The pump 108 is connected to the drain outlet, more precisely to the second end of the drain pipeline 106. The pump 108 is configured to pump the separated liquids from the second part 102 to the drain through the drain outlet. The pump 108 may be any pump suitable for pumping liquids from the second part 102 to the drain, for example, a submersible pump. The pump 108 may be connected to mains.

The pump 108 is arranged in a housing 109 having a lid 110 preventing biowaste to enter the housing 109 and pump 108 from above. The housing 109 having the lid 110 is also noteworthy, because when the lid of the housing 109 is opened i.e. lifted, the pump 108 and drain pipeline 106, when disconnected from the drain connection 107, can be lifted from the housing 109 and from the container 100 for maintenance or for changing without a need to remove the separating wall 103.

The container 100 is usually at least mainly arranged underground, but a part or parts of the container 100 can be overground part(s) i.e. surface part(s) or a part or parts of the container 100 may have a connection to the overground i.e. to the surface or a lid 112 may be above the ground surface. The container 100 can be placed in a trench, for example, on a concrete slab or other suitable material. It is however possible that the container 100 is fully arranged on the surface of the ground, for example, in a technical space of a house. The container 100 may be a solid structure made of, for example, polyethene, High-density polyethylene (HDPE) or some other suitable material and it may have been made, for example, by rotational molding. The size of the container 100 may be, for example, a few hundred liters to few thousand liters, for example, 500-4000 liters. The pipe and connections may be made of any suitable material, for example, acid-resistant steel (HST).

The two-part biowaste container 100 may further comprise a biowaste outlet 111a or 111b in the first part 101 of the container 100 for suction of non-separated and more solid part of the biowaste from the container 100. However, if there is no biowaste outlet 111a or 111b in the container 100, the suction can be performed by lifting off the container lid 112 for the time of emptying.

It is however possible that there is a drain connection in the second part 102 of the container 100 and separated liquids drains i.e. flow from the second part 102 directly to the drain due to gravity i.e. it is a gravity-operated drain connection. In this alternative solution there is no need for the pump 108, the housing 109 with lid 110, the drain pipeline 106 or the drain connection 107. This kind of structure is shown in FIGS. 5a and 6b.

It is also possible that the biowaste outlet 111a or 111b is formed so that it also comprises a connection or connections to the second part 102 of the container 100 and separated liquids including grease can be suctioned from the container 100 through it. In this structure the pump 108, the housing 109 with lid 110, the drain pipeline 106 and the drain connection 107 or a gravity-operated drain connection are needed. These one or more connections can also be used for flushing the container.

The two-part biowaste container 100 may further comprise a ventilation pipe or several ventilation pipes. Ventilation pipes are shown in FIGS. 5a, 6a and 6b.

It is also possible that the container 100 further comprises a biowaste mill (not shown), which is arranged, for example, fixed, in connection of the inlet 105 for crushed biowaste. The biowaste mill crushes biowaste before it enters to the container 100. Or if the biowaste is fed to the container through the lid 112, the biowaste mill is arranged in the lid 112. When the biowaste mill is fixed to the container 100, a water supply can be provided for it for preventing clogging of the mill.

In addition to above, the second part 102 of the container 100 may further comprise a separate drain and/or flush tube, pipe, or connection. Accessing to drain pipe may be placed, for example, to the lid 112 or somewhere else above the ground from which it is possible for a suction truck to access it. FIG. 1b shows an enlargement view of the mushroom-shaped valve 104 of FIG. 1a. The valve 104 comprises a mushroom foot 120 and a mushroom hat 121 with one or more holes i.e. openings 122 for the liquids under the mushroom hat 121 in the upper part of the mushroom foot 120. The direction of liquids is indicated by an arrow B.

FIG. 1c shows a view of the mushroom-shaped valve 104 and the separating layer 103 of FIG. 1b from above.

FIG. 1d shows a side view of the mushroom-shaped valve 104 of FIG. 1b without the hat 121 of the mushroom-shaped valve 104. The openings 122 are more clearly shown in this figure.

FIG. 1e shows a cross-sectional view of the inlet 105 for crushed biowaste of the two-part biowaste container 100 of FIG. 1a along a line A-A. The biowaste inlet 105 is connected to a pipeline 122, through which the crushed biowaste flows to the container 100. The flap 105a is arranged in front of the biowaste inlet 105 inside the container. The flap 105a prevents possible odors from entering the pipeline 123.

FIG. 1f shows a view of the biowaste inlet 105 of the two-part biowaste container 100 of FIG. 1e from direction of the inside of the container 100. The mouth of the inlet 105 and the flap 105a in front of the mouth of the inlet 105 are shown.

FIG. 1g shows one possible alternative for the mushroom-shaped valve 104 shown in FIG. 1b. The alternative valve 104a is shown as a side view. The valve 104a comprises a mushroom foot 120a and a mushroom hat 121a. The upper part of the mushroom foot 120a comprises at least one semi-circular opening 122a under the mushroom hat 121 through which liquids can flow to a lower i.e. second part of a container. It is however possible that the openings have any other shape than semicircle. The direction of liquids is indicated by an arrow B.

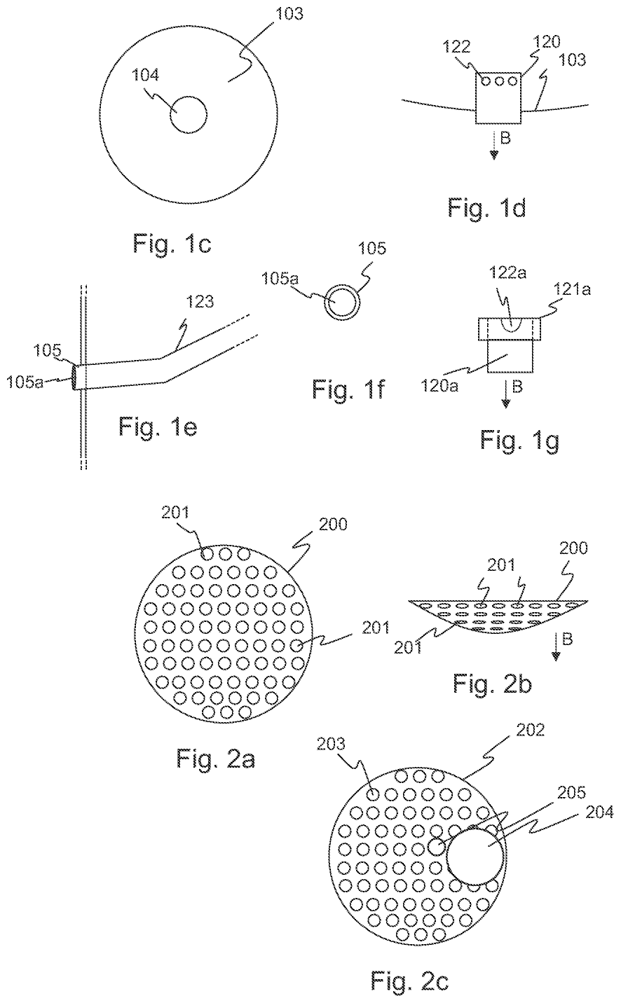

FIG. 2a shows from above a perforated separating layer 200 of a two-part container according to an example embodiment. The perforated separating layer 200 comprises several perforations 201. The perforated separating layer 200 is one of the options for a separating layer without perforations and comprising a mushroom-shaped valve or some other shaped valve for separating liquids or at least part of the liquids from the crushed biowaste from the upper part of the container to the lower part of the container.

FIG. 2b shows from a side the perforated separating layer 200 of FIG. 2a with perforations 201.

FIG. 2c shows from above a perforated separating layer 202 of a two-part container according to an example embodiment. The perforated separating layer 202 comprises perforations 203 and an opening 204 for a housing of a pump and a second opening 205 for a tubular housing of a water pressure sensor configured to measure liquid pressure level inside the tubular housing.

Perforations 201, 203 of the perforated separating layers 202 of FIGS. 2a-c are circular. Their diameter may be, for example 1-3 cm so that the liquid part of crushed biowaste will be filtered through the perforations 201, 203. Perforations of a perforated separating layer may, however, be rectangular. Their sides may have a length of, for example, 1.0-2.5 cm. The shape of perforations is not restricted to these shapes, but they may also be triangular, elliptical, hexagonal etc. But the size of the perforations is measured so that liquid part of the biowaste actually filters through them, but not the solid part of the biowaste i.e. perforations should not be too big. In addition, a separating layer should have an adequate number of perforations so that liquid part of the biowaste actually filters through them and does not just stay inside the upper second part of the two-part biowaste container. The diameter of a perforation of perforation may be, for example, 1 mm to 4 cm.

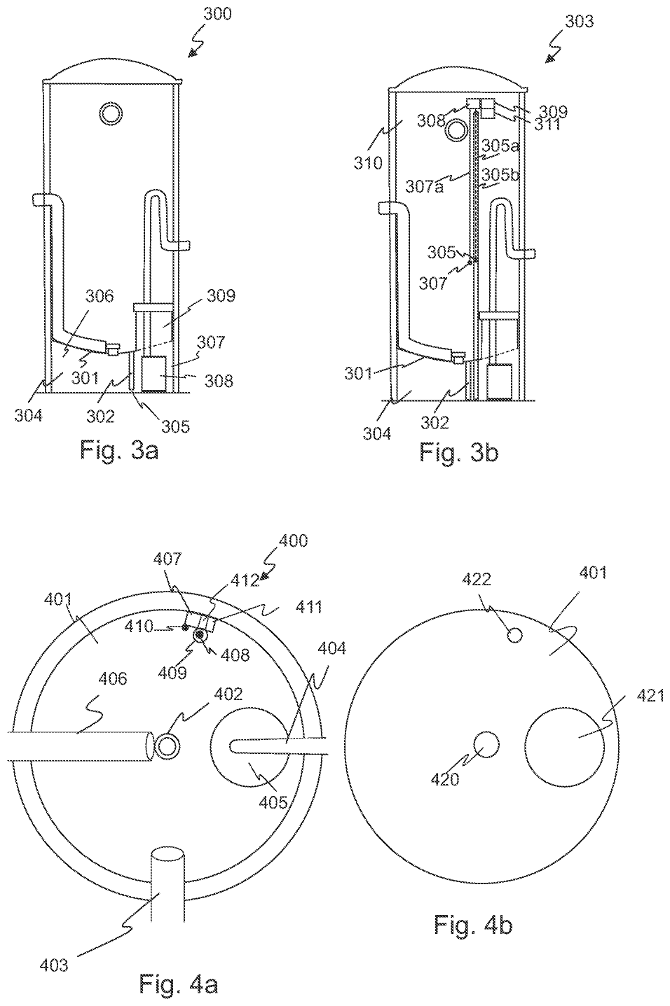

FIG. 3a shows a cross-sectional view of a two-part biowaste container 300 with a degreasing wall 302 according to an example embodiment. The degreasing wall 302 is in the lower second part 304 of the container 300 and underneath the separating layer 301 of the container 300. The upper part of the degreasing wall 302 is attached to the bottom of the separating layer 301, but there is a gap 305 for non-greasy liquid part of liquid 304 of the container 300. The gap 305 is between the lower end of the degreasing wall 302 and the floor of the container 300 (and the second part 304). In other words, the degreasing wall 302 is a wall in the second part 304 of the container 300 that is off the floor of the container 300 so that non-greasy part of liquid can move under the wall from a first side of the wall to a second side of the wall. The idea of the degreasing wall 302 is that the greasy part of the liquid and grease remains in the first side 306 of the degreasing wall 302 and non-greasy part of the liquid flows to the second side 307 of the degreasing wall 302 comprising the pump 308 arranged in the housing 309. This way, the pump 308 will not pump greasy liquids to a drain.

FIG. 3b shows a cross-sectional view of a two-part biowaste container 303 according to an example embodiment. The two-part biowaste container 303 comprises a water pressure sensor 305 and an ultrasonic sensor 307. The water pressure sensor 305 and its wiring 305a are arranged inside a tubular housing 305b. The water pressure sensor 305 is configured to measure liquid level inside the second part 304 of the container 303 by measuring water pressure level inside the housing 305a. The measuring element of the water pressure sensor 305 may be, for example, piezo resistive Silicon Chip. The ultrasonic sensor 307 is configured to measure biowaste level inside the first part 310 of the container 300. The two-part biowaste container 303 further comprises an electrical box 308 into which the sensors 305, 307 are electrically connected and which supplies electricity to the sensors 305, 307. In connection with the electrical box 308, there may be a data transferring unit 309. In this example embodiment, there are wired connections 305a, 307a between the sensors 305, 307 and the electrical box 308 and between the sensors 305, 307 and the data transferring unit 309. But it is also possible that there is a wireless connection between the sensors 305, 307 and the data transferring unit 309. The sensors 305, 307 transmit their measurement data i.e. readings to the data transferring unit 309 comprising a transceiver or transmitter or to a control unit 311 configured to control the pump. The data transferring unit 309 is configured to transmit those readings for analysis, for example, to an external computing device, a cloud service, etc. The two-part biowaste container 303 also comprises a degreasing wall 302.

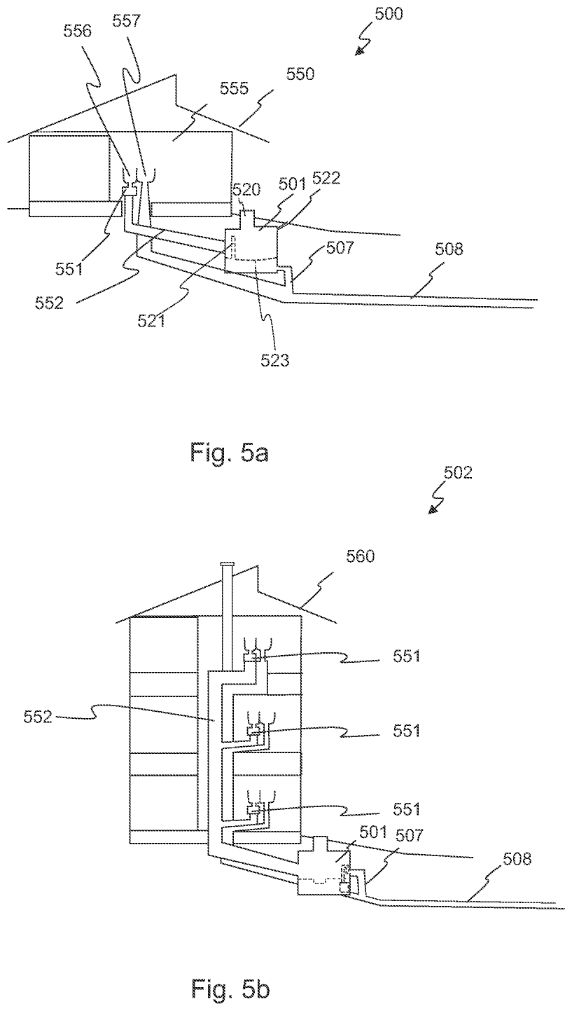

FIG. 4a shows from above a two-part biowaste container 400 according to an example embodiment. In FIG. 4a there are shown a separating wall 401 and its separating valve 402 configured to separate liquids from the crushed biowaste. The two-part biowaste container 400 further comprises a biowaste outlet 406 and an inlet 403 for crushed biowaste and a drain outlet 404 comprising a drain pipeline, which first end is connected to a drain connection. The two-part biowaste container 400 also comprises a pump (not shown) arranged inside a container with a lid 405. Further there is shown an electrical box 407, a water pressure sensor 408 inside a tubular housing 409, an ultrasonic sensor 410, a data transferring unit 411 and a control unit 412.

FIG. 4b shows from above the separating layer 401 of the two-part biowaste container of FIG. 4a with a valve opening 420 for the valve 402, a pump opening 421 for the container and its lid 405, and a sensor opening 422 for the water pressure sensor 408 and its tubular housing 409.

FIG. 5a shows a biowaste collection system 500 comprising a two-part biowaste container 501 according to an example embodiment. The biowaste collection system 500 is arranged in a single-family house 550. The biowaste collection system 500 comprises only one biowaste mill 551 that is fixed under a first sink 556 of a kitchen 555 of the house 550 for crushing biowaste, a biowaste drain 552 for crushed biowaste, the above mentioned two-part biowaste container 501, a main drain 508, and a drain connection 507 connected to the main drain 508. The biowaste drain 552 is connected between the biowaste mill 551 and the two-part biowaste container 501. The crushed biowaste is arranged to flow from the biowaste mill 551 to the two-part biowaste container 501 through the biowaste drain 552. The drain connection 507 is connected to the two-part biowaste container 501 via a gravity-operated drain connection so that the liquids separated from the crushed biowaste in the two-part biowaste container 501 can flow to the drain connection 507 wherefrom it flows along the drain connection 507 to the main drain 508 and further to a sewerage network. The main drain 508 is connected to a second sink 557 in the kitchen of the house 550 and through the main drain 508 water and other liquids fed to the second sink 557 will flow to the sewerage network.

The biowaste container 501 itself is arranged underground and it has a lid structure 520. The biowaste container 501 has a biowaste outlet on top, through the lid structure 520, or on the side of it (not shown) so that it is possible to empty the non-filtered part (solid part) of the crushed biowaste from the biowaste container 501 by a vehicle comprising a suction device or some other means suitable for emptying the biowaste container 501. The lid structure 520 may be such that it is possible to entry to the container 501 through it.

By a ventilation pipe 522, the first part 501 of the container can be ventilated and by a ventilation pipe 521, the second part 502 of the container can be ventilated. A degreasing wall 523 is also shown in the second part of the container. Thus, the liquid flowing to the drain connection 507 connected to the main drain 508 is non-greasy.

Also in the case of, for example, commercial kitchens there could be only one biowaste mill that crushes biowaste to a biowaste drain. Furthermore, there may be the at least one biowaste mill and a water supply device that are arranged in connection with a sink. The at least one biowaste mill may be positioned under the sink.

FIG. 5b shows a biowaste collection system 502 comprising a two-part biowaste container 501 according to an example embodiment. The biowaste collection system is arranged in an apartment building 560 comprising several, in this embodiment three, apartments. The biowaste collection system 502 comprises a biowaste mill 551 connected under a first sink of each or at least part of the kitchens of the building 560 for crushing biowaste, a biowaste drain 552, the above mentioned two-part biowaste container 501, a main drain 508, and a drain connection 507 connected to the main drain 508. The biowaste drain 552 is connected between the biowaste mills 551 and the two-part biowaste container 501. The crushed biowaste is arranged to flow from each biowaste mill 551 to two-part biowaste container 501. Each biowaste mill 551 has its own biowaste drain line 552a, 552b, 552c and each of the drain lines 552a, 552b, 552c is tied into the biowaste drain 552, which takes the crushed biowaste out of the house 560 and to the two-part biowaste container 501. The biowaste drain 552 may have a bigger diameter than a diameter of a biowaste drain line 552a, 552b, 552c, but not necessarily. It is also possible to say that there is just a branched biowaste drain, instead of saying that there is a biowaste drain and a biowaste drain line or lines.

The crushed biowaste is arranged to flow from the biowaste mills 551 to the two-part biowaste container 501 through the drain lines 552a, 552b, 552c and the biowaste drain 552. The drain connection 507 is connected to a pump in the second part of the two-part biowaste container 501 and via the drain connection 507 the liquids separated from the crushed biowaste in the two-part biowaste container 501 can be pumped to the drain connection 507 wherefrom it flows along the drain connection 507 to the main drain 508 and further to a sewerage network. The main drain 508 is also connected to second sinks 557 in the kitchens of the house 560 and through the main drain 508 water and other liquids that are fed to a second sink 557 flow directly to the sewerage network without going to the two-part biowaste container 501.

The two-part biowaste container 501 is again arranged underground, and its biowaste outlet is connected to the surface of ground so that the non-filtered part of the crushed biowaste can be emptied from the two-part biowaste container 501 by a vehicle comprising a suction device or some other means suitable for emptying the two-part biowaste container 501.

FIG. 6a shows a cross-sectional view of a two-part biowaste container 600 for a biowaste collection system according to an example embodiment. The two-part biowaste container 600 comprises again two separate portions i.e. parts, a first part 601 and a second part 602 underneath the first part 601. There is a separating wall 604 between the first part 601 and the second part 602. The separating wall 604 may have a concave shape so that its center is lower than its edges. The container works as described, for example, in context with FIG. 1a.

In this example embodiment, the two-part biowaste container 600 comprises two ventilation pipes 603a and 603b. The number of ventilation pipes in the container may however be one or more than two, for example, three to five. The ventilation pipe 603a is arranged in the upper part of the first part 601 of the container 600 (it may also be arranged in the lid 612 as it has a stretched shape) and air and other gases can flow through it out of the first part 601 of the container 600. The ventilation pipe 603b is arranged between the first part 601 and second part 602 of the container 600 and air and other gases can flow through the ventilation pipe 603b from the second part 602 to the first part 601 of the container 600. Thus, by the ventilation pipe 603a, the first part 601 of the container 600 can be ventilated and by the ventilation pipe 603b, the second part 602 of the container 600 can be ventilated. Further, the container 600 according to this example embodiment comprises a degreasing wall 605 according to an example embodiment. The degreasing wall 605 is a wall 606 in the second part 602 of the container 600 comprising a pipe connection 607 in from a first side 610 of the wall 606 to a second side 611 of the wall 606. Through the pipe connection 607 non-greasy part of the liquids can flow from the first side 610 of the wall 606 to the second side 611 of the wall 606 wherefrom the pump 608 pumps it to the drain. The opening of pipe connection 607 in first side 610 of the wall 606 is so low that only non-greasy part of liquids will flow through the pipe connection 607, because the greasy part of liquids floats on the surface of the non-greasy of liquids and the surface level is higher than the opening of the pipe connection 607. The shape of the pipe connection 607 is ascending and the non-greasy part of the liquids flows to the second side 611 due to the capillary phenomenon.

The container 600 further comprises an electrical lead-through opening 620 in the upper part of the first part 601 of the container 600. Through the opening 620, electricity may be supplied for the pump 608 and possibly also for other electronics inside the container, for example, for one or more sensors. The opening 620 may also be used for other wires needed, etc.

FIG. 6b shows a cross-sectional view of a two-part biowaste container 600 for a biowaste collection system according to an example embodiment. The two-part biowaste container 600 comprises a degreasing wall 605 and a gravity-operated drain connection 620. The drain connection 620 of the container 600 is arranged in the side of the container 600 and it is connected to a main drain 621. There is a concrete layer 630 under the container 600, for example, a concrete slab. Gravity-operated means that the liquids in a second side 611 of the degreasing wall 605 flow to the main drain 621 through the drain connection 620 due to the gravity without a need for a pump or other transferring means.

The degreasing wall 605 comprises two adjacent walls in the second part 602 of the container 600. A first wall 613 of the two adjacent walls i.e. of the degreasing wall 605 that is in a first side 610 of the degreasing wall 605 is off the floor of the container 600. A second wall 614 that is in the second side 611 of the degreasing wall 605 is off the ceiling of the second part 602 of the container 600. The second wall 614 of the two adjacent walls is on a side of the drain connection 620. The non-greasy part of the liquids flows from under the first wall 613. This is because the greasy part of liquids floats on the surface of the non-greasy part of the liquids, and the surface level is at a higher level than the gap under the first wall 613. When the level of the non-greasy part of the liquids between the walls 613, 614, reach an adequate level i.e. the level of the upper part of the second wall 614, it flows from above the second wall 614 to the second side 611 of the degreasing wall 605, and further to the drain connection 620 and the main drain 621. The greasy part of the liquids remains in the first side 610 of the degreasing wall 605. The second part 602 may further comprise a maintenance door 630, even if there is no pump in the second part 602. The maintenance door 630 may be, for example, a lid or corresponding structure in the separating wall of the container 600.

Thus, despite of a shape of a degreasing wall of a container, its function is to separate grease from other liquids in the second part of the container so that only the non-greasy part of the liquids flows or will be pumped to the main drain.

The shape i.e. form of a lid of a two-part biowaste container may vary, but it is such that emptying and maintaining of the container is possible through it. It may have a stretched form as shown in FIGS. 5a, 5b, and 6a, which is so that only the lid reaches above the level of the ground, or its form may be flatter as shown in FIGS. 1b, 3a, 3b, and 6b, which form is such that also the upper part of the container reaches or almost reaches at the level of the ground.

The separating wall between a first and second parts of a container may alternatively have a plane shape, but its center area may be lower around a separating valve. Example of this kind of structure is shown in FIG. 5b.

The various embodiments may provide advantages. The use of biowaste mills is easy for the users, and biowaste mills may comprise all necessary means that guarantee secure use of the mills. There is no need to collect stinking biowaste in separate bags or containers in the kitchen and then carry the collected biowaste into biowaste bin outside. Furthermore, the collected biowaste, wherefrom a liquid part of the biowaste is separated, is easy and non-odorous to be stored in a biowaste container. And from the two-part biowaste container the biowaste is easy to collect for further use, for example, to biogas production. Easy and safe collecting of biowaste increases the amount of collected biowaste, which, in turn, increases the amount of biogas raw material and the amount of produced biogas, and decreases the amount of waste exported to landfill.

It is obvious that the aspects of the disclosed embodiments are not limited solely to the above-presented embodiments but features of example embodiments can be combined, and the aspects of the disclosed embodiments can further be modified within the scope of the appended claims.

1. A two-part biowaste container for crushed biowaste comprising:
a first part of the container for solid part of the crushed biowaste,
a second part of the container for liquids separated from the crushed biowaste, which second part of the container is arranged below the first part of the container,
a separating wall between the first part and the second part,
a drain connection in the second part for separated liquids,
the two-part biowaste container further comprises a separating valve arranged to the separating wall and being configured to separate at least a part of the liquids from the crushed biowaste from the first part to the second part of the container,
wherein the separating valve is a mushroom-shaped valve comprising in the upper part of the mushroom foot one or more openings for liquids to be separated to the second part of the biowaste container.

2. The two-part biowaste container according to claim 1, wherein the drain connection is a pump arranged inside the second part of the container, which pump is configured to pump the separated liquids from the second part to a drain through a drain outlet.

3. The two-part biowaste container according to claim 1, wherein the drain connection is a gravity-operated drain connection in the second part of the container and the gravity-operated drain connection is connected to a main drain.

4. The two-part biowaste container according to claim 1, wherein the two-part biowaste container further comprises an inlet for crushed biowaste.

5. The two-part biowaste container according to claim 1, wherein the two-part biowaste container further comprises a degreasing wall in the second part of the container for separating grease from other liquids.

6. The two-part biowaste container according to claim 5, wherein the degreasing wall is a wall in the second part of the container that is off the floor of the container.

7. The two-part biowaste container according to claim 5, wherein the degreasing wall is a wall in the second part of the container comprising a pipe connection for non-greasy part of liquids flowing from a first side of the wall to the second side of the wall through the pipe connection.

8. The two-part biowaste container according to claim 5, wherein the degreasing wall comprises two adjacent walls in the second part of the container wherein a first wall of the two adjacent walls is off the floor of the container and a second wall of the two adjacent walls is off the ceiling of the second part of the container.

9. The two-part biowaste container according to claim 1, wherein the container further comprises a water pressure sensor configured to measure liquid level in the second part of the container or an ultrasonic sensor configured to measure biowaste level in the first part of the container.

10. The two-part biowaste container according to claim 1, wherein the pump is a submersible pump.

11. The two-part biowaste container according to claim 1, wherein the container further comprises a housing with a lid for the pump.

12. The two-part biowaste container according to claim 1, wherein the container further comprises a biowaste outlet in the first part of the container for suction of non-separated part of the crushed biowaste from the container.

13. The two-part biowaste container according to claim 1, wherein the container further comprises a biowaste mill for crushing biowaste before entering to the container, wherein the biowaste mill is arranged in connection of an inlet of the container for crushed biowaste or if biowaste is fed to the container through a lid of the container, the biowaste mill is arranged in the lid.

14. A biowaste collection system comprising a biowaste mill for crushing biowaste, a biowaste drain for crushed biowaste, a two-part biowaste container according to claim 1, wherein the biowaste drain is arranged between the biowaste mill and the two-part biowaste container so that the crushed biowaste is diverted to the first part of the two-part biowaste container through the biowaste inlet.

15. The biowaste collection system according to claim 14, wherein the two-part biowaste container is arranged to receive crushed biowaste from at least one biowaste mill through the biowaste drain.

16. The biowaste collection system according to claim 14, wherein the biowaste mill is arranged under a first sink for receiving biowaste to be crushed by the biowaste mill.

17. The biowaste collection system according to claim 14, wherein the biowaste collection system further comprises a second sink for water and other liquids that is connected to a main drain.

18. The biowaste collection system according to claim 14, wherein the biowaste collection system is in common for at least two buildings.

19. A method for collecting solid part and liquid part of crushed biowaste separately, the method comprises:
receiving crushed biowaste to a first part of the container for solid part of the crushed biowaste,
separating at least a part of the liquids from the crushed biowaste to a second part of the container through a separating valve arranged to a separating wall arranged between the first part and the second part, which second part of the container is arranged below the first part of the container, so that the solid part of the crushed biowaste remains in the first part of the container, wherein the separating valve is a mushroom-shaped valve comprising in the upper part of the mushroom foot one or more openings for liquids to be separated to the second part of the biowaste container.

20. The according to claim 19, wherein the method is performed by a two-part biowaste container.
